(19) United States
(12) Patent Application Publication
(10) Pub. No.: US 2014/0325114 A1
(43) Pub. Date: Oct. 30, 2014

(54) MULTI-CHANNEL DIRECT MEMORY ACCESS CONTROLLER AND CONTROL METHOD THEREOF

(71) Applicant: CORE LOGIC INC., Seoul (KR)

(72) Inventor: SUK-KYU SONG, Yongin-si (KR)

(73) Assignee: CORE LOGIC INC., Seoul (KR)

(21) Appl. No.: 14/259,383

(22) Filed: Apr. 23, 2014

(30) Foreign Application Priority Data
Apr. 26, 2013 (KR) 10-2013-0046898

(51) Int. Cl. G06F 13/30

(52) U.S. Cl. CPC G06F 13/30
USPC 710/308

(57) ABSTRACT

Disclosed herein is a multi-channel direct memory access (DMA) controller. The DMA controller includes: a register which stores control information and an operation state of each of a plurality of direct memory access (DMA) channels; a transmission processor which controls flow of transmission and reception of data such that all of the DMA channels requesting DMA transmission cyclically repeat unit transmission with reference to the register; and a transmission sequence control unit which controls the transmission processor such that the transmission sequence of each of the DMA channels is determined in a circulation cycle of unit transmission by reflecting priority information of the respective DMA channels stored in the register.

### CROSS-REFERENCE TO RELATED APPLICATION

This application claims priority to Korean Patent Application No. 10-2013-0046898 filed on 26 Apr., 2013, and all the benefits accruing therefrom under 35 U.S.C. §119, the contents of which is incorporated by reference in its entirety.

### BACKGROUND

1. Technical Field

The present invention relates to a direct memory access (DMA) controller supporting multiple channels, and a control method thereof.

2. Description of the Related Art

Direct memory access (DMA) is a method for transmitting data between a memory and peripheral devices independently of a central processing unit (CPU) of a computer system. DMA allows data to be directly transmitted without passing through the central processing unit, thereby reducing load of the central processing unit while improving overall system performance.

### BRIEF SUMMARY

It is an aspect of the present invention to provide a multi-channel DMA controller, which efficiently performs DMA transmission scheduling in response to a DMA transmission request of each channel so as to satisfy Quality of Service (QoS), and a control method thereof.

It is another aspect of the present invention to provide a multi-channel DMA controller that realizes DMA transmission scheduling in a way that each channel cyclically repeats unit transmission, and a control method thereof.

It is a further aspect of the present invention to provide a multi-channel DMA controller that realizes DMA transmission scheduling so as to satisfy QoS by reflecting priorities of respective channels on DMA transmission sequence in a single circulation cycle upon cyclic repetition of unit transmission of the respective channels, and a control method thereof.

In accordance with one aspect, the present invention provides a multi-channel DMA controller includes: a register which stores control information and an operation state of each of a plurality of direct memory access (DMA) channels; and a transmission processor which controls flow of transmission and reception of data such that all of the DMA channels requesting DMA transmission cyclically repeat unit transmission with reference to the register.

The present invention provides the multi-channel DMA controller, which further includes: a transmission sequence control unit controlling the transmission processor such that transmission sequence of each of the DMA channels is determined in a circulation cycle of unit transmission by reflecting priority information of the respective DMA channels stored in the register.

The present invention provides the multi-channel DMA controller, in which the transmission sequence control unit determines the transmission sequence of at least two DMA channels having the same priority information stored in the register based on time points of DMA transmission requests.

The present invention provides the multi-channel DMA controller, which further includes: an interface unit updating the priority information stored in the register by receiving data for update of the priority information.

In accordance with another aspect, the present invention provides a control method of multi-channel DMA, which includes: receiving DMA transmission requests from peripheral devices assigned DMA channels; and controlling flow of transmission and reception of data such that all of the DMA channels requesting DMA transmission cyclically repeat unit transmission with reference to control information and operation states of the respective DMA channels.

The present invention provides the control method of multi-channel DMA, in which controlling flow of transmission and reception of data includes: determining a transmission sequence of the respective DMA channels in a circulation cycle of unit transmission by reflecting priority information of the respective DMA channels.

The present invention provides the control method of multi-channel DMA, which further includes: updating the priority information of the respective DMA channels stored in a register by receiving data for update of the priority information of the respective DMA channels.

According to the present invention, DMA transmission scheduling can be efficiently performed to satisfy Quality of Service (QoS) in response to a DMA transmission request of each channel.

In addition, since the respective channels cyclically repeat unit transmission so as to prevent a specific channel from exclusively occupying DMA transmission too long, a maximum period of time can be secured upon transmission of small amounts of data.

Further, since priority sequence of the channels is reflected on DMA transmission sequence in one circulation cycle, a data transmission request of an input/output device assigned a higher priority is more rapidly processed, thereby satisfying QoS.

### BRIEF DESCRIPTION OF THE DRAWINGS

The above and other aspects, features, and advantages of the present invention will become apparent from the detailed description of the following embodiments in conjunction with the accompanying drawings, in which:

FIG. 1 is a schematic diagram of a system including a DMA controller according to one embodiment of the present invention;

FIG. 2 is a schematic diagram of a system including a multi-channel DMA controller according to one embodiment of the present invention;

FIGS. 3a and 3b are a flowchart showing DMA transmission scheduling of a multi-channel DMA controller according to one embodiment of the present invention; and

FIG. 4 is a flowchart showing a control method of multi-channel DMA according to one embodiment of the present invention.

### DETAILED DESCRIPTION

Terms used in the following description and claims should be interpreted as having a meaning that is consistent with their meaning in the context of the specification and relevant art, and should not be interpreted in an idealized or overly formal sense as defined in commonly used dictionaries, since the inventors can properly define the concept of the terms in order to describe their invention in the best way. In addition, embodiments disclosed in the specification and the features shown in the drawings are merely preferred embodiments of the present invention and do not cover the entire technical idea of the present invention. Thus, it should be understood that such embodiments may be replaced by various equivalents and modifications at the time point when the present application is filed.

The present invention relates to a direct memory access (DMA) controller supporting multiple channels and a control method thereof, and more particularly, to a multi-channel DMA controller, which efficiently performs DMA transmission scheduling in response to DMA transmission request of respective channels so as to satisfy Quality of Service (QoS), and a control method thereof. Hereinafter, exemplary embodiments of the present invention will be described in detail with reference to the accompanying drawings.

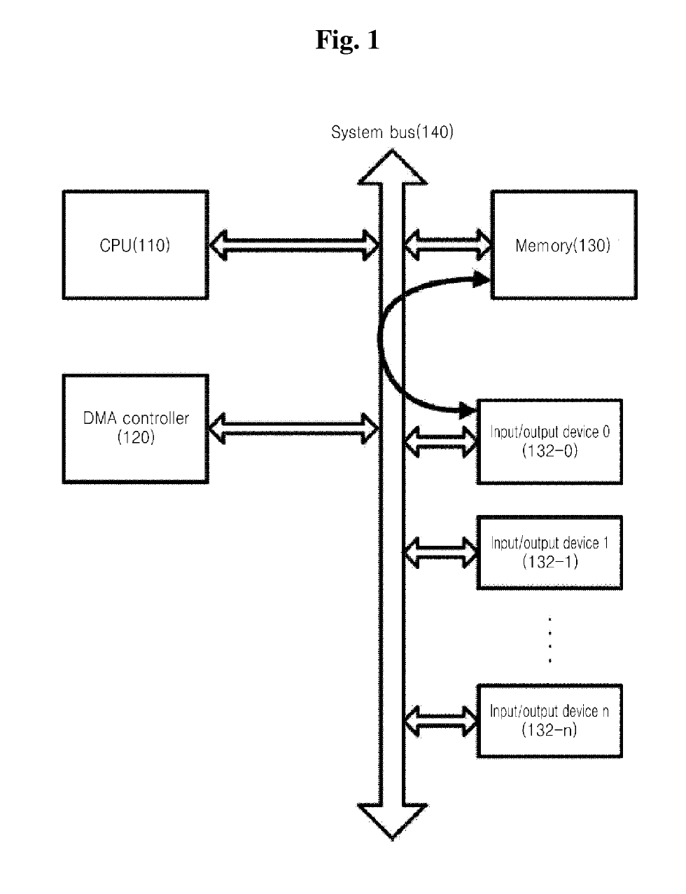

FIG. 1 is a schematic diagram of a system including a DMA controller according to one embodiment of the present invention.

Referring to FIG. 1, a central processing unit (CPU) 110 may communicate with a DMA controller 120 through an address bus and a system bus 140, and may initiate the DMA controller 120 via the system bus 140. The DMA controller 120 supporting a plurality of channels is provided to process DMA transmission requests from a plurality of input/output devices 132-0 to 132-n.

The DMA controller 120 supporting the plural channels receives the DMA transmission requests from the respective input/output devices 132-0 to 132-n, and processes the transmission requests. More particularly, for DMA transmission via a specific channel, the DMA controller 120 allows the CPU 110 to abandon the system bus 140, and transmits a DMA transmission acceptance signal to a corresponding input/output device (for example, 132-0) to realize communication between a memory 130 and the input/output device 132-0. Here, specific channels are assigned to the input/output devices 132-0 to 132-n, respectively. Thus, since the plurality of DMA transmission requests may be simultaneously or sequentially received, the DMA controller 120 is required to perform scheduling of DMA transmission work.

However, most methods of typically scheduling DMA transmission work simply follow sequence of receiving the DMA transmission requests by the DMA controller 120. In this case, there is a problem in that, when the DMA transmission request received first requires transmission of a large amount of data and is not urgent, the urgent DMA transmission request received in the next sequence is not processed for a while. That is, the method of scheduling DMA transmission work by so-called arrival order cannot reflect an emergency level based on features of respective transmission data.

In addition, there can be a method in which priorities are imparted to input/output devices connected to respective channels based on features of the input/output devices, and a DMA transmission processing sequence is adjusted based on the priorities. However, if a certain channel having a higher priority requires transmission of a large amount of data, there is a problem in that the channel having a lower priority must wait for a long period of time even for a transmission request for a small amount of data.

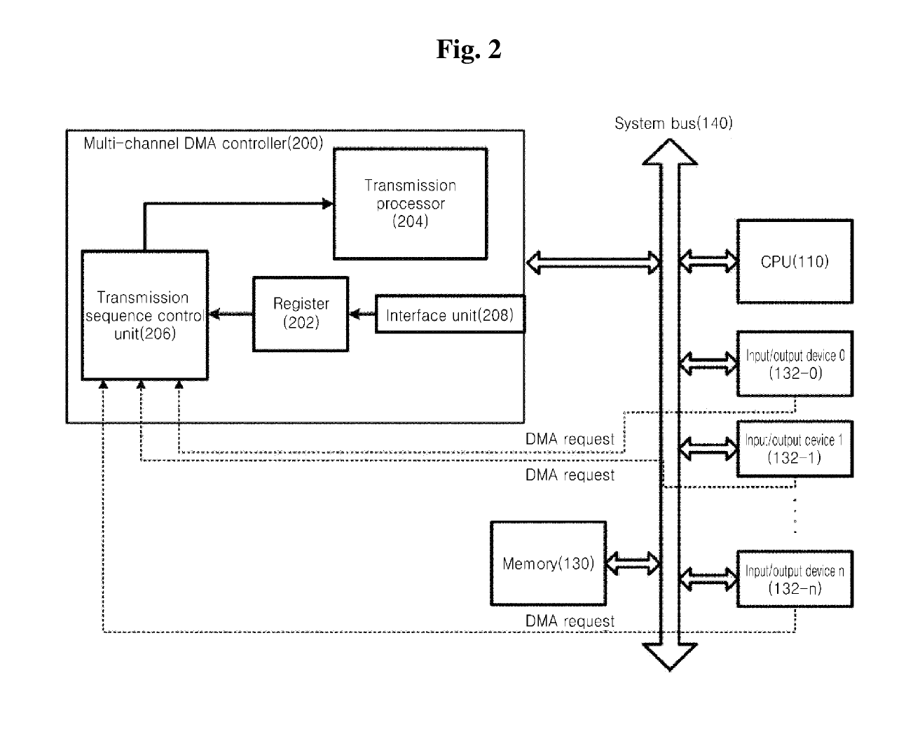

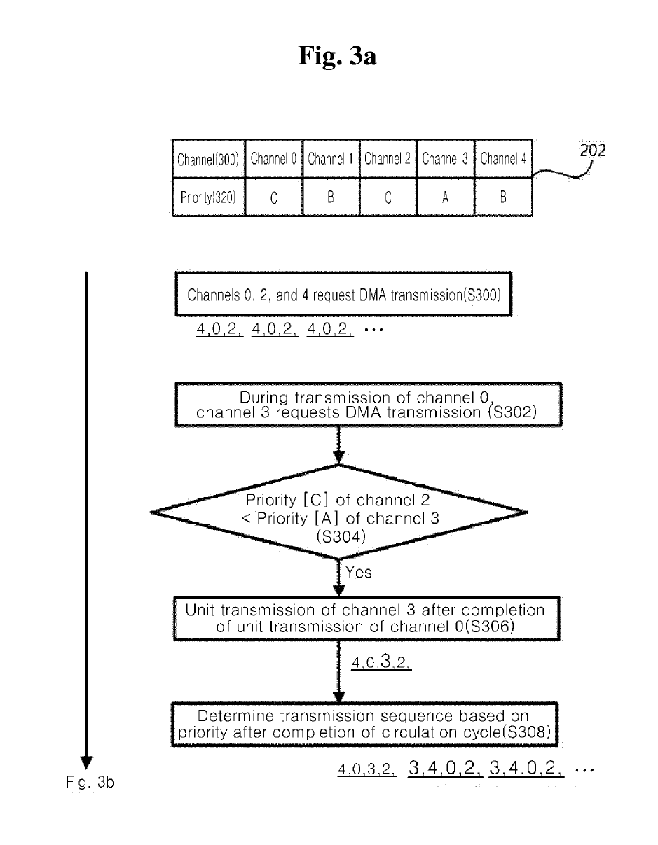

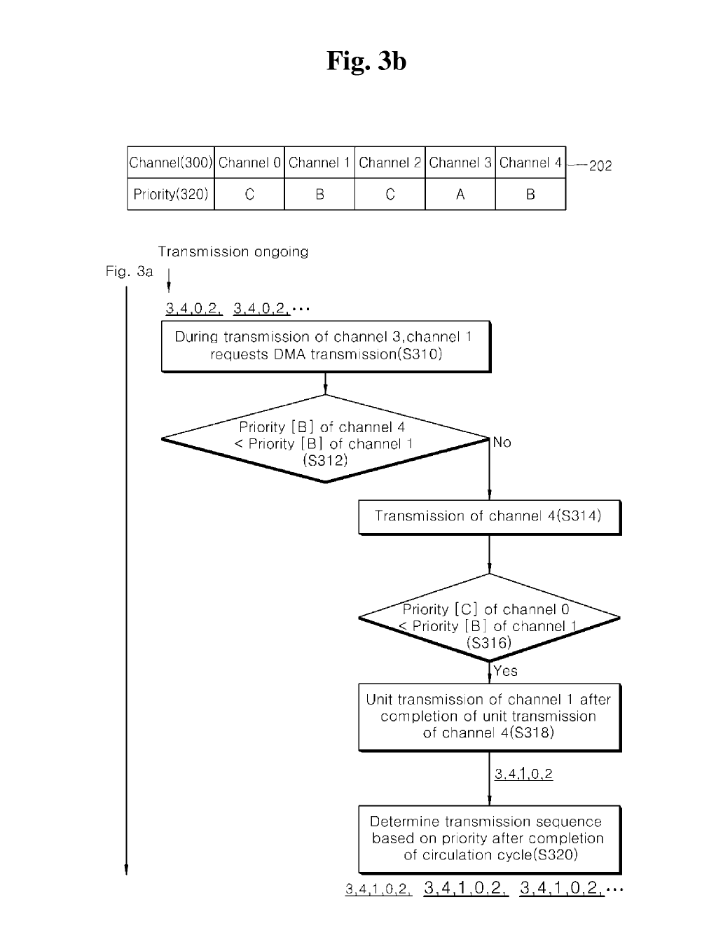

First, a multi-channel DMA controller according to one embodiment of the present invention will be described in detail with reference to FIGS. 2, 3a and 3b.

FIG. 2 is a schematic diagram of a system including a multi-channel DMA controller 200 according to one embodiment of the present invention.

Referring to FIG. 2, the system includes a CPU 110, input/output devices 0 to n (132-0 to 132-n), a memory 130, and a system bus 140. Since these components are the same as those described above with reference to FIG. 1, descriptions thereof will be omitted.

According to one embodiment, a multi-channel DMA controller 200 may include a register 202 and a transmission processor 204. The register 202 may store control information and an operation state of each of a plurality of direct memory access (DMA) channels. The register 202 may include registers which are assigned to the channels such that one register corresponds to one channel. For example, when the DMA controller 200 is designed to support five channels, the register 202 may include five registers. Control information of each of the channels stored in the register 202 may mean information required to process DMA transmission, and an operation state of each of the channels stored in the register 202 may mean information regarding whether DMA transmission of the corresponding channel is performed.

The transmission processor 204 may control flow of transmission and reception of data such that all of the DMA channels requesting DMA transmission cyclically repeat unit transmission with reference to the register 202. Here, unit transmission may mean that only transmission of a predetermined amount of data is performed during one transmission unit. For example, in the DMA controller 200 supporting five channels A, B, C, D, E, when each of the five channels requests transmission of data of 10 kilobytes, if a data amount of unit transmission is 1 kilobyte, the transmission processor 204 may control flow of transmission and reception of data such that each of channels A, B C, D, E cyclically repeats transmission of data of 1 kilobyte ten times. In this case, since the respective channels cyclically repeat unit transmission such that a specific channel does not exclusively occupy DMA transmission too long, a maximum period of time can be secured upon transmission of small amounts of data.

In addition, the multi-channel DMA controller 200 may further include a transmission sequence control unit 206 that controls the transmission processor 204 to determine transmission sequence of the respective DMA channels in a circulation cycle of unit transmission by reflecting priority information of the respective DMA channels. The priority information of the respective DMA channels may be stored in the register 202. The transmission sequence control unit 206 may control the transmission processor 204 such that a higher-priority channel in the circulation cycle of unit transmission performs DMA transmission prior to other channels. Control of transmission sequence in the circulation cycle of unit transmission enables more rapid processing of DMA transmission as the amount of data to be transmitted decreases and the number of channels increases.

Further, the transmission sequence control unit 206 may determine the transmission sequence based on time points of DMA transmission requests with regard to at least two DMA channels, which have the same priority information stored in the register 202. For example, for the channels having the same priority, the transmission sequence in the circulation cycle of unit transmission may be determined according to so-called arrival order based on the time points of the DMA transmission requests.

When there is a new DMA transmission request, the transmission sequence control unit 206 may update the transmission sequence in the circulation cycle of unit transmission. The transmission sequence may be updated when the circulation cycle of unit transmission is completed. That is, when the circulation cycle of unit transmission is completed, the transmission sequence control unit 206 may rearrange the transmission sequence of all of the DMA channels requesting DMA transmission in the circulation cycle of unit transmission by reflecting priority information. In this case, unit transmission in response to the new DMA transmission request is not performed until the circulation cycle of unit transmission is completed.

Alternatively, when there is a new DMA transmission request, the transmission sequence control unit 206 may permit unit transmission in response to the new DMA transmission request even before the corresponding circulation cycle is completed. Here, when there is a new DMA transmission request, unit transmission of which is not performed, during the circulation cycle of ongoing unit transmission, the transmission sequence control unit 206 may determine a DMA channel, which will perform the next DMA transmission, through comparison of priority of a DMA channel related to the new DMA transmission request with priority of a DMA channel, at which the next DMA transmission is scheduled to be performed.

For example, when the DMA channel related to the new DMA transmission request has a higher priority than the DMA channel at which the next DMA transmission is scheduled to be performed, the transmission sequence control unit 206 may determine the DMA channel, which will perform the next DMA transmission, as a DMA channel in response to the new DMA transmission request.

Hereinafter, operation of the multi-channel DMA controller 200 according to one embodiment of the invention, which schedules DMA data transmission work by reflecting priorities of DMA channels, will be described in detail with reference to FIGS. 3a and 3b.

FIGS. 3a and 3b are flowcharts showing DMA transmission scheduling of a multi-channel DMA controller according to one embodiment of the present invention.

For convenience of understanding, priority information 320 of respective channels 300 stored in the register 202 is shown in FIGS. 3a and 3b. Priorities are denoted by capital letters. A represents a highest priority, B represents a middle priority, and C represents a lowest priority.

First, referring to FIG. 3a, a state in which channels 0, 2 and 4 sequentially request DMA transmission is assumed (S300). In the state in which channels 0, 2 and 4 request DMA transmission, a single circulation cycle consists of unit transmission of channel 4, unit transmission of channel 0, and unit transmission of channel 2 by reflecting the priorities of the channels. Although channels 0 and 2 have the same priority of C, since channel 0 makes an earlier DMA transmission request than other channels, channel 0 may be in an earlier unit transmission sequence than channel 2. The circulation cycle may be repeated until data transmission of the respective channels is completed.

During DMA transmission of channel 0, when an input/output device assigned channel 3 requests DMA transmission (S302), the transmission sequence control unit 206 may compare the priority of channel 2 scheduled to perform the next transmission with the priority of channel 3 requesting transmission (S304). Based on a comparison result, since channel 3 has higher priority, unit transmission of channel 3 may be performed instead of channel 2 (S306) after completion of transmission of channel 0. Here, DMA transmission of channel 2 scheduled to perform the next transmission is merely postponed to the next sequence, and unit transmission in the corresponding circulation cycle is not canceled. Thus, as shown in FIG. 3a, unit transmission in the circulation cycle at a time point of a DMA transmission request of channel 3 is performed in sequence of channels 4, 0, 3 and 2.

However, the sequence of channels 4, 0, 3 and 2 for unit transmission in the circulation cycle may not be maintained in the next circulation cycle. In this case, since channel 3 is the third in unit transmission sequence despite having the highest priority, the transmission sequence control unit 206 may rearrange the transmission sequence of all of the DMA channels requesting DMA transmission in the circulation cycle by reflecting the priority information when the circulation cycle of unit transmission is completed. In this example, in the circulation cycle after rearrangement, unit transmission is performed in the sequence of channels 3, 4, 0, and 2.

Referring to FIG. 3b, when the DMA transmission request of channel 1 is received during transmission of channel 3 in the circulation cycle of channels 3, 4, 0 and 2 (S310), the transmission sequence control unit 206 may compare the priority of channel 4 scheduled to perform unit transmission after unit transmission of channel 3 with the priority of channel 1 (S312). Based on a comparison result, since channels 1 and 4 have the same priority of B, unit transmission may be performed in original sequence after completion of unit transmission of channel 3. Since there is a new DMA transmission request, unit transmission of which is not performed, during the circulation cycle of ongoing unit transmission even after completion of unit transmission of channel 4, the transmission sequence control unit 206 compares the priority of channel 0 scheduled to perform unit transmission after unit transmission of channel 4 with the priority of channel 1 (S316) again. Here, since channel 1 has higher priority than channel 0, unit transmission of channel 1 may be performed prior to channel 0 (S318). Thus, as shown in FIG. 3b, unit transmission in the circulation cycle at a time point of the DMA transmission request of channel 3 is performed in the sequence of channels 3, 4, 1, 0 and 2. In this case, since the circulation sequence of channels 3, 4, 1, 0 and 2 matches the priorities thereof and the sequence of DMA transmission requests as well, the circulation sequence can be maintained even after the circulation sequence is rearranged (S320) by the transmission sequence control unit 206.

### Example

### Transmission of Different Amounts of Data

Although the aforementioned unit transmission is illustrated as permitting only transmission of the same amounts of data to the respective channels during one transmission unit, unit transmission may also permit transmission of different amounts of data to the respective channels.

The register 202 may store a unit transmission data amount for each of the plural DMA channels. Here, the transmission processor 204 may transmit as much data as the unit transmission data amount stored in the register 202 upon unit transmission to each of the DMA channels.

On the other hand, even in the case where the unit transmission data amount of each of the plural DMA channels is not stored in the register 202, the unit transmission data amount may be determined based on priority information of each of the DMA channels. For example, a channel having a priority of A grade may have a unit transmission data amount of 300 kilobytes, a channel having a priority of B grade may have a unit transmission data amount of 200 kilobytes, and a channel having a priority of C grade may have a unit transmission data amount of 100 kilobytes. That is, a channel having a higher priority may have a larger unit transmission data amount. Conversely, channel having a higher priority may also have a smaller unit transmission data amount. Here, the transmission processor 204 may transmit as much data as the unit transmission data amount based on the priority of each of the DMA channels when performing unit transmission to each of the DMA channels.

### Example

### Method for Determining Priority Using Data Amount

The transmission sequence control unit 206 may also determine the transmission sequence of the respective DMA channels in the circulation cycle of unit transmission by reflecting the unit transmission data amounts of the respective DMA channels. For example, the transmission sequence control unit 206 may perform unit transmission to a channel having a small unit transmission data amount prior to other channels. In this case, a DMA transmission request of an input/output device, which mainly performs transmission of a small amount of data, can be processed first. Conversely, the transmission sequence control unit 206 may also perform unit transmission to a channel having a large unit transmission data amount prior to other channels.

### Example

### Determination of Transmission Sequence in Consideration of Priority and Data Amount

The transmission sequence control unit 206 may also determine the transmission sequence of the respective DMA channels in the circulation cycle of unit transmission in consideration of the priority information of the respective DMA channels and the unit transmission data amounts, which are stored in the register 202. For example, the transmission processor 204 may be controlled such that unit transmission to the DMA channel having a higher priority and a smaller unit transmission data amount is performed first.

In addition, the multi-channel DMA controller 200 may further include an interface unit 208 which updates data stored in the register 202 by receiving information for update of the data stored in the register 202. Since data capable of being stored in the register 202 include data about the priorities of the respective channels and data about the unit transmission data amounts thereof, the interface unit 208 can update the data stored in the register 202 by receiving at least one of the data about the priorities of the respective channels and the data about the unit transmission data amounts thereof.

The respective components of FIG. 2 described above may mean software or hardware, such as a field-programmable gate array (FPGA) or an application-specific integrated circuit (ASIC). However, the components are not limited to software or hardware, and may be configured to be stored in an addressable storage medium and may also be configured to execute at least one processor. Capabilities of the components may be implemented by subdivided components or by one component obtained by combining a plurality of components to perform a specific capability.

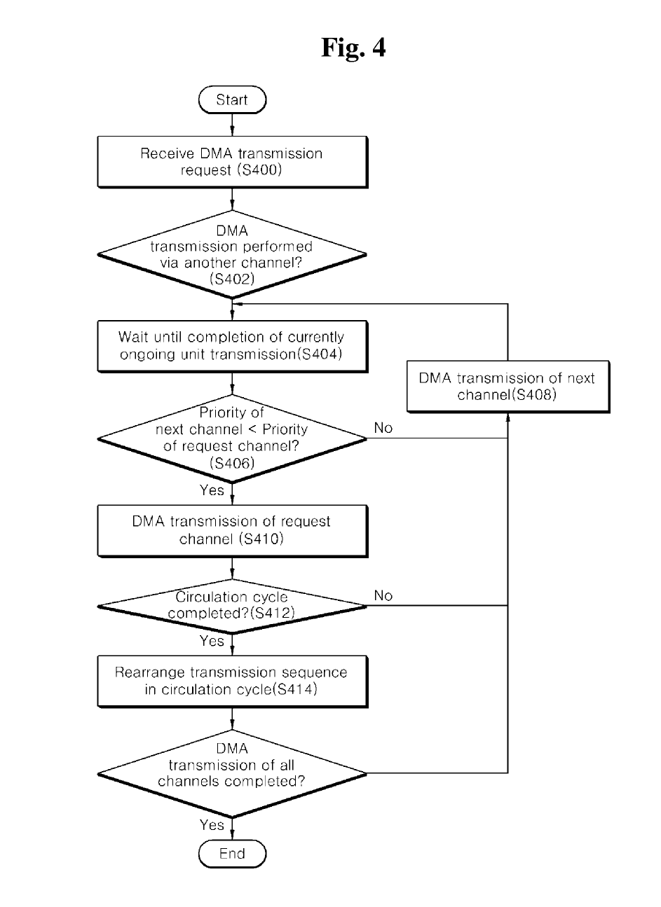

FIG. 4 is a flowchart of a control method of multi-channel DMA according to one embodiment of the present invention.

Referring to FIG. 4, the multi-channel DMA controller 200 may receive DMA transmission requests from peripheral devices assigned DMA channels (S400). The multi-channel DMA controller 200 may control flow of transmission and reception of data such that all of the DMA channels requesting DMA transmission cyclically repeat unit transmission with reference to control information and operation states of the respective DMA channels. In this case, unit transmission may be performed such that only a predetermined amount of data is transmitted during one transmission unit.

From operation in which the multi-channel DMA controller 200 controls flow of transmission and reception of data, requested DMA transmission may be immediately processed unless DMA transmission is being processed via another channel. However, if DMA transmission is being processed via another channel (S402), the requested DMA transmission may wait until currently ongoing unit transmission is completed. When currently ongoing unit transmission is completed, the priority of the channel scheduled to perform the next unit transmission may be compared with the priority of the channel requesting DMA transmission (S406). Comparison of operation in S406 may also be performed even before unit transmission is completed.

From the results of comparison of operation in S406, if the channel requesting DMA transmission does not have a higher priority than the channel scheduled to perform the next unit transmission, unit transmission of the channel scheduled to perform the next unit transmission may be performed as scheduled.

However, from the results of comparison of operation in S406, if the channel requesting DMA transmission has a higher priority than the channel scheduled to perform the next unit transmission, unit transmission of the channel requesting DMA transmission may be performed prior to unit transmission of the channel scheduled to perform the next unit transmission (S410).

When the circulation cycle is completed (S412), transmission sequence in the circulation cycle may be rearranged (S414). Through rearrangement, the transmission sequence in the circulation cycle may be modified by reflecting the DMA transmission request sequences and the priorities.

The control method of multi-channel DMA may be repeatedly performed until transmission of all channels is completed (S416).

Although some embodiments have been described herein, it should be understood by those skilled in the art that these embodiments are given by way of illustration only, and that various modifications, variations, and alterations can be made without departing from the spirit and scope of the invention. Therefore, the scope of the invention should be limited only by the accompanying claims and equivalents thereof.

What is claimed is:

1. A multi-channel direct memory access (DMA) controller, comprising:
a register storing control information and an operation state of each of a plurality of DMA channels; and
a transmission processor controlling flow of transmission and reception of data such that all of the DMA channels requesting DMA transmission cyclically repeat unit transmission with reference to the register,
wherein the unit transmission is performed such that only a predetermined amount of data is transmitted during one transmission unit.

2. The multi-channel DMA controller according to claim 1, further comprising:
a transmission sequence control unit controlling the transmission processor such that transmission sequence of the respective DMA channels is determined in a circulation cycle of unit transmission by reflecting priority information of the respective DMA channels stored in the register,
wherein the register further stores the priority information of the respective DMA channels.

3. The multi-channel DMA controller according to claim 2, wherein the transmission sequence control unit determines the transmission sequence based on time points of DMA transmission requests with regard to at least two DMA channels having the same priority information stored in the register.

4. The multi-channel DMA controller according to claim 2, wherein, when unit transmission for a new DMA transmission request is not performed during the circulation cycle of ongoing unit transmission, the transmission sequence control unit determines a DMA channel, which will perform the next DMA transmission, by comparison of priority of a DMA channel related to the new DMA transmission request with priority of a DMA channel at which the next DMA transmission is scheduled to be performed.

5. The multi-channel DMA controller according to claim 4, wherein, when the DMA channel related to the new DMA transmission request has a higher priority than the DMA channel at which the next DMA transmission is scheduled to be performed, the transmission sequence control unit determines the DMA channel, which will perform the next DMA transmission, as a DMA channel in response to the new DMA transmission request.

6. The multi-channel DMA controller according to claim 4, wherein, when the circulation cycle of unit transmission is completed, the transmission sequence control unit rearranges the transmission sequence of all of the DMA channels requesting DMA transmission in the circulation cycle by reflecting the priority information of the DMA channels.

7. The multi-channel DMA controller according to claim 2, further comprising:
an interface unit updating the priority information stored in the register by receiving data for update of the priority information.

8. The multi-channel DMA controller according to claim 1, wherein the register further stores a unit transmission data amount of each of the plural DMA channels, and the transmission processor transmits data as much as the unit transmission data amount stored in the register when performing unit transmission for each of the DMA channels.

9. The multi-channel DMA controller according to claim 8, further comprising:
an interface unit updating the unit transmission data amount of each of the plural DMA channels stored in the register by receiving data for update of the unit transmission data amount of each of the plural DMA channels.

10. The multi-channel DMA controller according to claim 8, further comprising:
a transmission sequence control unit controlling the transmission processor to determine transmission sequence of the respective DMA channels in a circulation cycle of unit transmission by reflecting the unit transmission data amounts of the respective DMA channels stored in the register.

11. A control method of multi-channel direct memory access (DMA), comprising:
receiving DMA transmission requests from peripheral devices assigned DMA channels; and
controlling flow of transmission and reception of data such that all of the DMA channels requesting DMA transmission cyclically repeat unit transmission with reference to control information and information about operation states of the respective DMA channels,
wherein the unit transmission is performed such that only a predetermined amount of data is transmitted during one transmission unit.

12. The control method according to claim 11, wherein the controlling flow of transmission and reception of data further comprises determining transmission sequence of the respective DMA channels in a circulation cycle of unit transmission by reflecting priority information of the respective DMA channels.

13. The control method according to claim 12, further comprising:
updating the priority information of the respective DMA channels stored in the register by receiving data for update of the priority information of the respective DMA channels.

14. The control method according to claim 12, wherein, when unit transmission for a new DMA transmission request is not performed during the circulation cycle of ongoing unit transmission, the controlling flow of transmission and reception of data further comprises determining a DMA channel, which will perform the next DMA transmission, by comparison of priority of a DMA channel related to the new DMA transmission request with priority of a DMA channel at which the next DMA transmission is scheduled to be performed.

15. The control method according to claim 14, further comprising: rearranging the transmission sequence of all of the DMA channels requesting DMA transmission in the circulation cycle by reflecting the priority information when the circulation cycle of unit transmission is completed.
